(19) United States
(12) Patent Application Publication
(10) Pub. No.: US 2025/0077208 A1
(43) Pub. Date: Mar. 6, 2025

(54) SOFTWARE PACKAGE DISTRIBUTION IN MANAGED NETWORKS

(71) Applicant: Ivanti, Inc., South Jordan, UT (US)

(72) Inventors: Collin Anderson, South Jordan, UT (US); Lester Memmott, South Jordan, UT (US)

(73) Assignee: Ivanti, Inc., South Jordan, UT (US)

(21) Appl. No.: 18/821,970

(22) Filed: Aug. 30, 2024

Related U.S. Application Data
(60) Provisional application No. 63/535,848, filed on Aug. 31, 2023.

(51) Int. Cl. G06F 8/61; H04L 67/104

(52) U.S. Cl. CPC G06F 8/61; H04L 67/104

(57) ABSTRACT

A method of executable storage in a peer-to-peer based software package distribution system. The method includes receiving an instruction to install a software package. An executable configured to execute installation of the software package may be available at a uniform resource location (URL). The method includes detecting a designation parameter. The method includes generating a subfolder name based on the designation parameter. The method includes searching a local cache folder and a peer cache folder for the executable based on the subfolder name. Responsive to the executable being unavailable at the local and peer cache folders, the method includes downloading the first executable from the URL. The method includes generating a subfolder for the executable in the local cache folder. The subfolder has the generated subfolder name. The method includes storing the executable in the generated subfolder.

### CROSS REFERENCE TO RELATED APPLICATION

This application claims the benefit of and priority to U.S. Provisional Patent Application No. 63/535,848 filed Aug. 31, 2023, which is incorporated herein by reference in its entirety.

### FIELD

The embodiments described in this disclosure are related to management of computer networks, and in particular to software package distribution in SAAS-based managed networks implementing peer-to-peer resource distribution.

### BACKGROUND

Application distribution in managed networks may be implemented to ensure that nodes of the managed network have installed a particular set of applications with a particular set of characteristics. For instance, application distribution may be implemented in the managed network to initiate installation of the latest version of a first application on one or more of the nodes or may be implemented to ensure the nodes all have a second application installed and enabled.

Application distribution in the managed networks consumes considerable computing resources. For instance, application storage consumes computer storage resources, application communication consumes bandwidth, and installation instructions consume processing resources of a management device. To mitigate resource consumption, some application distribution systems may implement a peer-to-peer distribution model between the nodes. In the peer-to-peer distribution model, a first node may share an application or installation files associated with the application with a one or more peer nodes, which may reduce downloads of the application or the installation files from a third-party source. For instance, the first node may download the application or the installation files. Following the installation of the application, the first node may locally store the application or the installation files in its cache storage. A peer node may later access the application or the installation files from the cache storage of the first node. The peer-to-peer distribution model reduces a number of times the application is downloaded, which reduces bandwidth utilization.

In some instances, however, an ability of peer nodes to locate the stored application or installation files may be limited. For instance, many executable files that trigger and manage application installation have the same file name. For instance, a first executable for a first application may be named webexapp.exe and a second executable for a second application may also be named webexapp.exe. Accordingly, the first executable may be stored at a first node after the first application is installed. Following the installation of the second application, the second executable may overwrite the first executable (because the name is the same) or the second executable may not be locally stored.

In circumstances in which the second executable overwrites the first executable, problems may occur during application distribution operations. For instance, when a peer node requests the first application from a first node, the second executable may be returned instead of the first executable. The second application may be installed at the peer node instead of the first application. Alternatively, the second executable may be reviewed prior to communication to the peer node. Upon review, the first node or the peer node may recognize that it is the incorrect file and may communicate an error message and/or delete the first executable and re-download the second executable from a network location.

In circumstances in which the second executable is not locally stored because of the common file name similar problems may occur. For instance, when the peer node requests the second application, the first executable may be returned, which may result in the installation of an incorrect application. Alternatively, the first executable may be reviewed, which may result in an error message and/or deletion of the first executable and re-download of the second executable. Deletion of stored executables, re-downloading of executables, and potentially installation of incorrect applications result in computing inefficiencies, wasted bandwidth, and time delays. Accordingly, a need exists to improve executable storage in peer-to-peer based application distribution systems.

The subject matter claimed herein is not limited to embodiments that solve any disadvantages or that operate only in environments such as those described. Rather, this background is only provided to illustrate one example technology area where some embodiments described herein may be practiced.

### SUMMARY

An aspect of an embodiment includes a method of executable storage in a peer-to-peer based software package distribution system. The method may include receiving, at a first node of a managed network, an instruction to install a first software package. A first executable configured to execute installation of the first software package may be available at a network location that corresponds to a first uniform resource location (URL). Responsive to the instruction, the method may include detecting a designation parameter from a characteristic of the first executable or the first URL. The method may include generating a subfolder name based on the designation parameter. The method may include searching a local cache folder for the first executable based on the subfolder name. Responsive to the first executable being unavailable at the local cache folder, the method may include searching for the first executable in a peer cache folder of a peer node based on the subfolder name. Responsive to the first executable being unavailable at the peer cache folder, the method may include downloading the first executable from the first URL. The method may include generating a subfolder for the first executable in the local cache folder, the subfolder having the generated subfolder name. The method may include storing the first executable in the generated subfolder.

Another aspect of an embodiment includes a managed network configured for peer-to-peer based software package distribution. The managed network may include two or more nodes and a management device. The nodes may include a first node and a second node. The first node includes a first cache folder, and the second node includes a second cache folder. The management device may be configured to communicate instructions to the two or more nodes to install software packages. The first node may be configured to receive a first instruction from the management device to install a first software package. The first software package may be installed via execution of a first executable available at a first network location that corresponds to a first uniform resource location (URL). The first node may be configured to detect a first designation parameter from a characteristic of the first executable or the first URL responsive to the first instruction, generate a first subfolder name based on the first designation parameter, search the first cache folder of the first node for the first executable based on the first subfolder name, and search for the first executable in the second cache folder of the second node based on the first subfolder name responsive to the first executable being unavailable at the first cache folder. The first node may be configured to download the first executable from the first URL responsive to the first executable being unavailable at the second cache folder, and generate a first subfolder for the first executable in the first cache folder, the first subfolder having the first subfolder name. The first node may be configured to store the first executable in the first subfolder. The second node may be configured to receive a second instruction from the management device to install the first software package. The second node may be configured to detect the first designation parameter, generate the first subfolder name based on the first designation parameter, and search the second cache folder of the second node for the first executable based on the first subfolder name. The second node may be configured to search for the first executable in the first cache folder of the first node based on the first subfolder name responsive to the first executable being unavailable at the second cache folder, access the first executable in the first cache folder of the first node; and execute the first executable to install the first software package.

Another aspect of an embodiment includes a non-transitory computer-readable medium having encoded therein programming code executable by one or more processors to perform or control performance of any combination of the operations of the method of executable storage in a peer-to-peer based software package distribution system described above.

Yet another aspect of an embodiment includes a node of a subnet comprising one or more processors and a non-transitory computer-readable medium having encoded therein programming code executable by one or more processors to perform or control performance of any combination of the operations of the method of executable storage in a peer-to-peer based software package distribution system described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments of the present disclosure may be implemented;

FIG. 2 is a block diagram of an example software package distribution process that may be implemented in the operating environment of FIG. 1;

FIGS. 3A and 3B depict example folder structures that may be implemented in the software package distribution process of FIG. 2;

FIG. 4 illustrates an example computing system configured for self-election of a node in a subset; and

FIGS. 5A-5C are a flow chart of an example method of executable storage in a peer-to-peer based software package distribution system,

all according to at least one embodiment described in the present disclosure.

### DESCRIPTION OF SOME EXAMPLE EMBODIMENTS

Embodiments of the present disclosure are related to management of computer networks, and in particular to software package distribution in SAAS-based managed networks implementing peer-to-peer resource distribution. Some embodiments relate to distribution operations implemented by nodes of managed subnets and storage structures related to the distribution operations.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

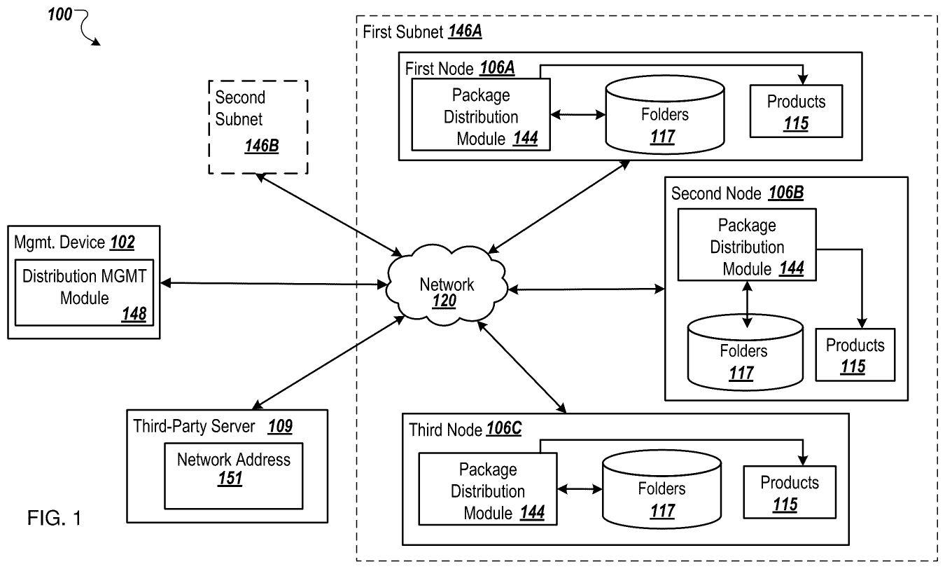

FIG. 1 is a block diagram of an example operating environment 100 in which some embodiments of the present invention can be implemented. The operating environment 100 may include a software as a service (SAAS) management network in which a management device 102 implements management services relative to one or more subnets 146A and 146B (generally, subnet 146 or subnets 146). The management services may include application management as well as one or more other management services such as patch management, asset management, vulnerability detection, service management, other management services or combinations thereof.

An aspect of application management is software package distribution. Software packages distributed to the subnets 146 or portions thereof may ensure that nodes 106A-106C (generally, node 106 or nodes 106) have loaded thereon a particular set of software applications that are configured in a particular way. For instance, the application management may include distribution of a new version of an operating system to the nodes 106 or distribution of a particular application to one or more of the nodes 106 based on a change in role of a user.

In the SAAS management network, the application management may involve instructions communicated from a management device 102. The instructions may include a uniform resource location (URL) of a network address 151 at which an executable or other installation files such as license keys, installation scripts, or other supporting files for a software package are located. In the present disclosure, the executable, license keys, installation scripts, and the supporting files are collectively referred to collectively as “executable” or “executables.” The URL enables the node(s) 106 to download and run the executable, which results in installation of the software package.

In the subnets 146, a peer-to-peer distribution model may be implemented. The peer-to-peer distribution model enables peer nodes 106 to request software packages from one another. For instance, to install a first software package, a first node 106A may access and download a first executable from a network address 151 at a third-party server 109. After the first node 106A downloads the first executable, the first node 106A may execute the first executable to install the first software package. Subsequently, a peer node 106B or 106C may request the first executable from the first node 106A instead of downloading it from the network address 151. The peer-to-peer distribution model reduces bandwidth utilization and computing resources used in the download process.

However, many executables have the same name. Accordingly, in conventional systems, storage and management of executables at the nodes 106 is difficult and error prone. For instance, two executables having the same name may be stored at the first node 106A. Accordingly, when one of the peer nodes 106B or 106C request one of these executables, another executable having the same name may be returned. The incorrect executable may result in an incorrect software application being installed or may result in an error. The error may then trigger the peer node 106B or 106C to download the executable from the network address 151.

Accordingly, some embodiments relate to storage operations for executables and file structures for executables to ensure each of the executables may be individually identified and distributed. The storage operations generate subfolders for the executables based on designation parameters. The designation parameters are closely related to a particular software package and/or to a particular executable. For instance, the designation parameters may be unique to the particular executable such as a URL at which the particular executable is accessible or a hash value of the URL. Additionally or alternatively, the designation parameters may be unique to the software package such as an identifier assigned to a particular software package.

The subfolders are named using the designation parameters or derivatives thereof. Accordingly, the executables are stored in subfolders with subfolder names that are substantially unique to the executable and/or the software package. Thus, the subfolders enable directed searches to the subfolders and the executable stored therein.

These and other embodiments improve software package distribution. For instance, executables with the same name are stored in different subfolders with different subfolder names. Accordingly, each of the executables with the same name may have a different, independent full path from which the executable can be discovered and distributed. Moreover, the subfolder names are generated based on the designation parameter associated with the software package or executable. Accordingly, each node 106 is able to conduct a search for the executable based on data that is independently detected and locally derived.

The operating environment 100 includes the management device 102, the third-party server 109, and the subnets 146, which include the nodes 106. The management device 102, the third-party server 109, the subnets 146, and the nodes 106 (collectively referred to as environment components) that are configured to communicate data and information related to software package distribution via a network 120. Each of the environment components and the network 120 are introduced in the following paragraphs.

The network 120 may include any communication network configured for communication of signals between the environment components. The networks 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some embodiments, the network 120 may include a peer-to-peer network. The network 120 may also be coupled to or include portions of a telecommunications network that may enable communication of data in a variety of different communication protocols.

In some embodiments, the network 120 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented with the nodes 106 and the management device 102.

The operating environment 100 of FIG. 1 includes two subnets 146A and 146B. A first subnet 146A is representative of a second subnet 146B. For instance, the first subnet 146A and the second subnet 146 may include multiple nodes 106 communicatively coupled via the network 120. The subnets 146 may be managed groups of nodes 106. Management of the nodes 106 includes application management and may additionally include other computing services such as IT support, endpoint management, and the like. The software package distribution processes described in the present disclosure may be an element or a service included in a computing service package.

The subnets 146 may be associated with an enterprise, a portion of an enterprise, a government entity, or another entity or group of nodes 106 that are managed together. The services executed in the subnets 146 may include any suitable service implemented among a group of nodes 106. Some examples of the service may include pre-boot services (e.g., preboot execution environment (PXE) services), device discovery services and media streaming services (e.g., universal plug and play (UPnP)). The service may also be a Windows service, Linux/Unix daemon, or another standard process.

The third-party server 109 may include a hardware-based computing system that is configured to communicate with the other environment components via the network 120. The third-party server 109 may be associated with a product developer that develops one or more of products 115 that are loaded on the nodes 106. The product developer may make available executables at the network address 151. For instance, an executable implemented to install a software application or a software update may be available at the network address 151. To install the software application or the software update, one or more of the nodes 106 may access the executable at the network address 151, download it, and execute the executable to install the software application or the software update.

The management device 102 may include a hardware-based computing system. The management device 102 may be communicatively coupled to the subnets 146 and the nodes 106 therein via the network 120. In the depicted embodiment, the management device 102 is a separate, independent computing device that is located outside the subnets 146. In some embodiments, the management device 102 is included as a portion of one or more cloud-based servers or a distributed server functionality implemented across one or more cores in a remote cloud computing network.

The management device 102 may include a distribution management module 148 (in the figures “distribution management module 148”). The distribution management module 148 is configured to provide software package distribution management. For instance, the distribution management module 148 may discover the products 115 loaded on the nodes 106. Additionally, the distribution management module 148 may have information sufficient to determine whether the products 115 that are currently loaded on the nodes 106 are consistent with the products 115 specified for the nodes 106. Based on this and other information, the distribution management module 148 may be configured to communicate instructions to the nodes 106. The instructions may include installation instructions that direct the nodes to install a particular software package, point the nodes 106 to the network address 151, etc.

For example, the first node 106A may have a first product, a second product, and a third product loaded thereon. The distribution management module 148 may determine that the first product is an outdated version, and a fourth product should be installed. Accordingly, the distribution management module 148 may communicate the instructions to the first node 106A to download the latest version of the first product and to download the fourth product.

The nodes 106 may include a hardware-based computing devices that are configured to communicate with the other environment components via the network 120. The nodes 106 are configured to communicate with and receive instruction from the management device 102. The nodes 106 may be further configured to communicate data and information with the other nodes 106 in the subnet 146. For example, the nodes 106 may communicate with the management device 102 over an intranet or an extranet via the transmission control protocol/internet protocol (TCP/IP) or another suitable protocol. The nodes 106 may include endpoints in the first subnet 146A. Examples of the nodes 106 include desktop computers, laptop computers, tablet computers, servers, cellular phones, smartphones, routers, gaming systems, etc.

The nodes 106 include the products 115, folders 117, and a package distribution module 144. The products 115 may include applications, components, systems, drivers, of any kind or type. Some examples of the products 115 may include software applications, enterprise software, operating systems, similar computer-related features or components, or combinations thereof. The products 115 may differ between the nodes 106. For instance, the first node 106A might have a processor with different capacity than the processor of the second node 106B. The software package distribution processes described in the present disclosure may change or modify the products 115. For instance, installation and distribution of a software package may result in installation of a new product or a newer version of one of the products 115.

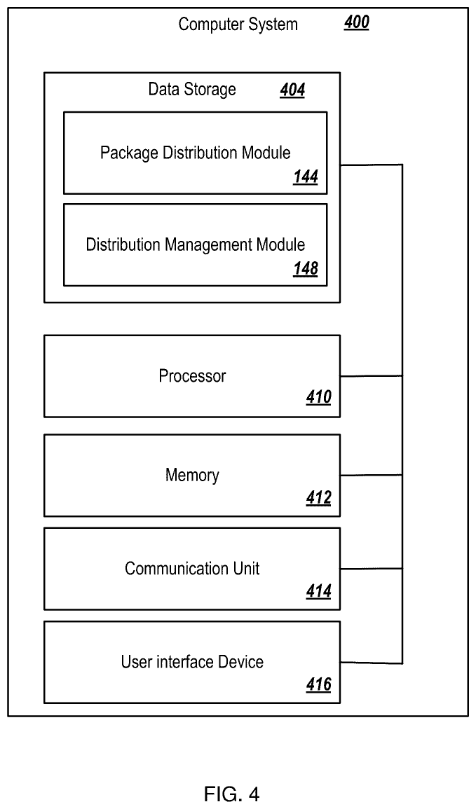

The folders 117 may include computer-readable storage media for carrying or having computer-executable instructions or data structures stored thereon (e.g., memory 412 of FIG. 4). The folders 117 may include a cache folder and/or a working folder in which subfolders are generated, executables are stored, and hard links are stored at least temporarily. The folders 117 may enable access to, execution of, and retrieval of files stored thereon.

The package distribution module 144 may be configured to receive instructions from the distribution management module 148 and perform distribution operations. For example, in some embodiments, the package distribution module 144 may receive an instruction to install one or more software packages. The one or more software packages may be associated with executables that are configured to install the software packages. The package distribution module 144 may detect a designation parameter based on the instruction or responsive to the instruction. The designation parameter may include a characteristic of the executable and/or the software package that is detectable by the nodes 106. For instance, the designation parameter may be unique to an executable such as the URL of an associated executable or a hash value of the URL. Additionally or alternatively, the designation parameter may be unique to the software package such as an identifier assigned to the software package. For instance, in some embodiments, the designation parameter may include the hash value of the URL. In some embodiments, the designation parameter may include an identifier assigned to the software package. In some embodiments, the designation parameter may be a combination of the hash value of the URL and the identifier. Accordingly, the designation parameter is detectable and substantially unique to the executable, the software package, or to a combination of the executable and the software package. The package distribution module 144 may generate a subfolder name based on the designation parameter or a derivative thereof.

The package distribution module 144 may perform one or more search operations based on the subfolder name. In some embodiments, the search operations may include a series of search operations such as a local search, followed by a peer node search, followed by downloading executables from the third-party server 109. For instance, a first search operation may include searching a local cache folder of the folders 117 for the executable based on the subfolder name. Responsive to the first executable being unavailable at the local cache folder, the package distribution module 144 may perform a second search operation that includes searching for the executable in a peer cache folder of one or more of the peer nodes 106 based on the subfolder name. Responsive to the executable being unavailable at the peer cache folder, the package distribution module 144 may download the executable from the network address 151.

When the executable is downloaded from the network address 151, instead of executing the executable, the package distribution module 144 may generate a subfolder for the executable. The subfolder may be generated in the local cache folder of the folders 117 in some embodiments. The subfolder includes the generated subfolder name. Because the subfolder name is derived from the designation parameter, the subfolder name is substantially unique to the software package and/or the executable. The package distribution module 144 may then store the first executable in the generated subfolder.

The package distribution module 144 may perform the above operations relative to multiple software packages, which may result in multiple executables stored in subfolders having unique folder names. Accordingly, executables with the same name are stored in subfolders with different names, which may enable a discrete full path to the executables.

To install the software packages, the package distribution module 144 may generate hard links. The hard links may be stored at least temporarily in the folders 117 such as in the local cache folder or in a working folder. To execute the executables, the nodes 106 may activate the hard link that triggers execution of the executable.

In some embodiments, the search operations may be different. The local search, followed by a peer search, followed by a download operation, may be modified. For instance, the local search may be omitted in the instruction. Additionally, the instruction may indicate which of the peer nodes 106 to search.

Additionally, in some embodiments, the nodes 106 or a portion thereof may include an agent. The agent may enable management functionality at the nodes 106. For instance, the agent may have a high level of privilege on the nodes 106, which enables visibility of the agent to the products 115 as well as operational parameters related to or characterizing the products 115. The agent may be configured to exist on the nodes 106 to support ongoing management of the nodes 106. The agent may be loaded onto the nodes 106 during a process in which the nodes 106 are enrolled in one of the subnets 146 or into a SAAS management network. In some embodiments, the package distribution module 144 may be a portion of the agent or may operate with the agent.

The package distribution module 144, the distribution management module 148, and components thereof may be implemented using hardware including a processor, a microprocessor (e.g., to perform or control performance of one or more operations), a field-programmable gate array (FPGA), or an application-specific integrated circuit (ASIC). In some other instances, package distribution module 144, the distribution management module 148, and components thereof may be implemented using a combination of hardware and software. Implementation in software may include rapid activation and deactivation of one or more transistors or transistor elements such as may be included in hardware of a computing system (e.g., the nodes 106, the management device 102, or the third-party server 109 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more management devices 102, one or more nodes 106, one or more subnets 146, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together into a single component or server or separated into multiple components or servers.

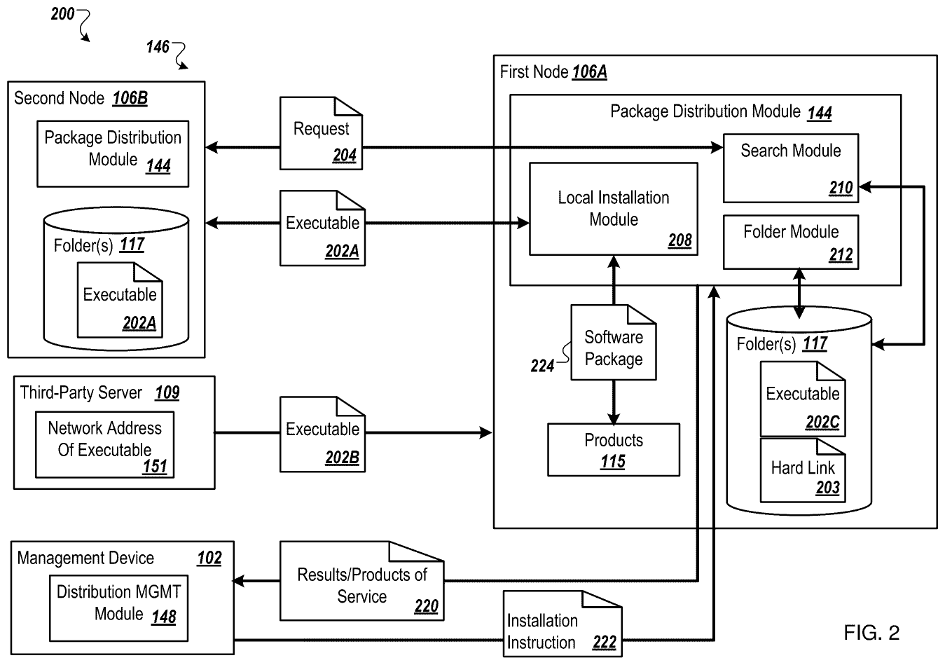

FIG. 2 is a block diagram of an example software package distribution process 200 (process 200) that may be implemented in the operating environment 100 of FIG. 1 or another suitable operating environment. The process 200 may be implemented in a managed network such as the subnet 146 that includes at least some peer-to-peer capabilities. The process 200 may include or involve one or more components (e.g., 106, 109, 102, etc.) described with reference to FIG. 1. Although not depicted in FIG. 2, one or more of the communications described with reference to FIG. 2 may be via the network 120 or another suitable communication network.

The process 200 of FIG. 2 is described with reference to the first node 106A and the second node 106B. It may be appreciated with the benefit of this disclosure that the process 200 may be performed by one or both of the nodes 106. Additionally, the functionality attributed to the first node 106A may be implemented by the second node 106B and vice versa.

The process 200 may be begin by the distribution management module 148 communicating an installation instruction 222 to the first node 106A. The installation instruction 222 may indicate a software package (e.g., 224 of FIG. 2) to be installed at the first node 106A. The software package may include a version change to one of the products 115, a new product, etc.

Installation of the software package may be performed through execution of an executable 202A-202C (generally, executable 202 or executables 202). The executable 202 may include machine code and/or compiled code that define a sequence of computer instructions that include installation instructions for the software package. Additionally, the executable 202 may include other installation support files such as license keys, installation scripts, etc. Selection, activation, or otherwise triggering the executable 202 may result in execution of the computer instructions directly by a processor (e.g., 410 of FIG. 4) such that the software package is installed at one of the nodes 106. Some examples of the executable 202 may be an EXE file, a WSF file, an SH file, a VBS file, a JS file, a KEY file, a BAT file, a COM file, a CMD file, an INF file, an IPA file, a OSX file, a PIF file, a RUN file, a WSH file, a TXT file, or another suitable executable file type.

The installation instruction 222 may include a URL for the executable 202. The URL may include the network address of the executable 202, which may be located on the third-party server 109 or another suitable network location. In some embodiments, the URL may be substantially unique to the executable 202. Additionally, in some embodiments, the installation instructions 222 may include an identifier that is assigned to the software package. For instance, the management device 102 may assign the identifier to the software package to enable tracking.

The package distribution module 144 may receive the installation instruction 222 from the management device 102. The package distribution module 144 may include a folder module 212. The folder module 212 may be configured to detect a designation parameter related to the installation of the software package 224. The designation parameter may be detected from a characteristic of the executable 202 or the URL. The designation parameter represents a value that is closely related to the executable 202 and/or the software package 224 and is detectable based on the installation instruction 222. As described elsewhere in the present disclosure, the designation parameter allows the nodes 106 to derive a subfolder name, which may be used as a basis of locating the executable 202. Accordingly, the designation parameter enables the nodes 106 to perform an informed search for the executable 202 locally and on peer nodes. The designation parameter further enables storage of two or more executables 202 with the same name because the storage is implemented in subfolders having subfolder names that can be differentiated.

The folder module 212 may be further configured to generate a subfolder name. The subfolder name is based on the designation parameter. In some embodiments, the folder module 212 may generate the subfolder name based on performance of an operation on the detected designation parameter. For instance, the characteristic may include the URL of the network address 151. The operation may include a hash operation such as the secured hash algorithm 1(SHA-1) to generate a URL hash value. In this example, the first subfolder name may include at least a portion of the URL hash value. For instance, the subfolder name may include a first seven characters of the URL hash value. The first seven characters is an example of the subfolder name. The subfolder name may include another length (e.g., five, six, eight, ten, etc. characters). Additionally or alternatively, the subfolder name may also include a different portion of the URL hash (e.g., a middle portion, a final portion, etc.). In some implementations, fewer than seven characters may not result in sufficient subfolder name differentiation for networks with large numbers of executables (e.g., greater than about 1000 executables).

In some embodiments, the subfolder name may be based on the identifier assigned to the software package 224. In these and other embodiments, the subfolder name may include at least a portion of the assigned identifier.

The folder module 212 may output the subfolder name to a search module 210 of the package distribution module 144. The subfolder name forms a basis of searches for the executable 202 performed by the first node 106A. For instance, the package distribution module 144 of each of the nodes 106 may be configured to store the executable 202 in a subfolder having the subfolder name. As stated above, the subfolder name differentiates the sub-folders because the subfolder name is derived from the designation parameter.

Accordingly, the search module 210 may search locally and at peer nodes 106 such as the second node 106B for a subfolder having the subfolder name. The search module 210 may search the folders 117 of the first node 106A. For instance, the search module 210 may search a cache folder of the first node 106A for local executable indicated in FIG. 2 by 202C based on the subfolder name. The local executable 202C may have been stored by the package distribution module 144 earlier. For instance, the first node 106A may have been instructed to install the software package 224 a month ago. A user of the first node 106A may have uninstalled the software package 224 for some reason (e.g., by mistake, the user did not like the software package 224, etc.). Accordingly, the local executable 202C may exist in the folders 117.

In response to the local executable 202C being stored in the folders 117 of the first node 106A, a local installation module 208 may access the local executable 202C and run or execute it. Execution of the local executable 202C may result in the software package 224 being installed at the first node 106A.

In response to the local executable 202C not being stored in the folders 117 of the first node 106A, the search module 210 may search the folders 117 of the second node 106B. For instance, the first node 106A may communicate a request 204 to the second node 106B. The request 204 may include the subfolder name generated for the software package 224. The package distribution module 144 at the second node 106B may receive the request 204 and conduct a search of the folders 117 of the second node 106B for a subfolder having the subfolder name and a peer executable, which is indicated by 202A in FIG. 2. The peer executable 202A may be stored in the folders 117 of the second node 106B because the second node 106B may have previously received an installation instruction (e.g., 222) to install the software package 224 from the management device 102. Accordingly, the second node 106B may have the software package 224 included in the products 115 of the second node 106B and stored the peer executable 202A during an installation process.

In response to the peer executable 202A being stored at the folders 117 of the second node 106B, the local installation module 208 of the first node 106A may access the peer executable 202A. The local installation module 208 may run or execute the peer executable 202A. For instance, in some embodiments, the local installation module 208 may copy the executable 202A to the folders 117. The copied executable may be stored in a subfolder having the generated subfolder name. The local installation module 208 may then create a hard link 203 in the folders 117 (e.g., in a local cache folder or a working folder). The local installation module 208 may then execute the executable 202 using the hard link 203. Execution of the executable 202A may result in the software package 224 being installed at the first node 106A.

In response to the peer executable 202A being unavailable in the folders 117 of the second node 106B, the local installation module 208 may download the remote executable, which is indicated by 202B in FIG. 2, using the URL. Downloading the remote executable 202B from the third-party server 109 is represented by executable 202B in FIG. 2. In the embodiment of FIG. 2, the URL may point to the network address 151 on the third-party server 109. The local installation module 208 may access the remote executable 202B at the network address 151 on the third-party server 109 and download the remote executable 202B.

The local installation module 208 may not automatically, immediately run the remote executable 202B. Instead, the local installation module 208 may communicate the remote executable 202B to the folder module 212. The folder module 212 may be configured to generate a subfolder for the remote executable 202B. The subfolder may be generated in the folders 117 such as in the cache folder of the first node 106A. The folder module 212 may then name the generated subfolder with the generated subfolder name. The folder module 212 may store the remote executable 202B in the subfolder. The executable 202 stored in the folders 117 is represented by the local executable 202C.

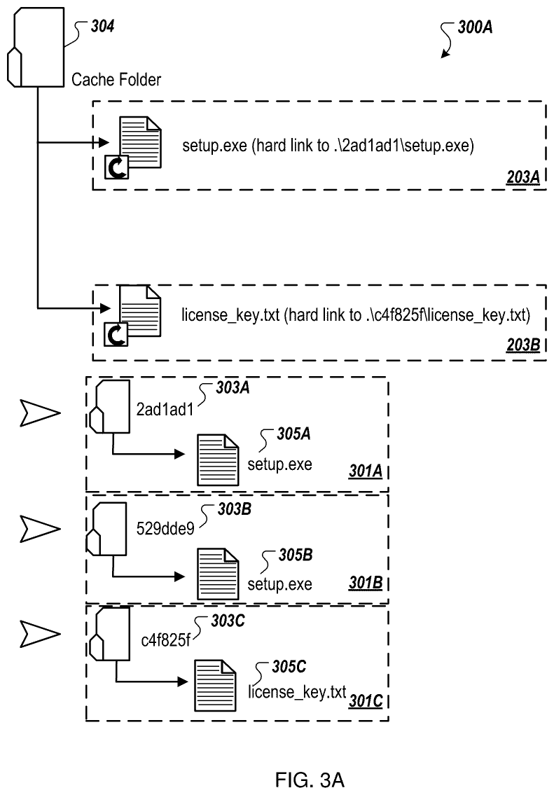

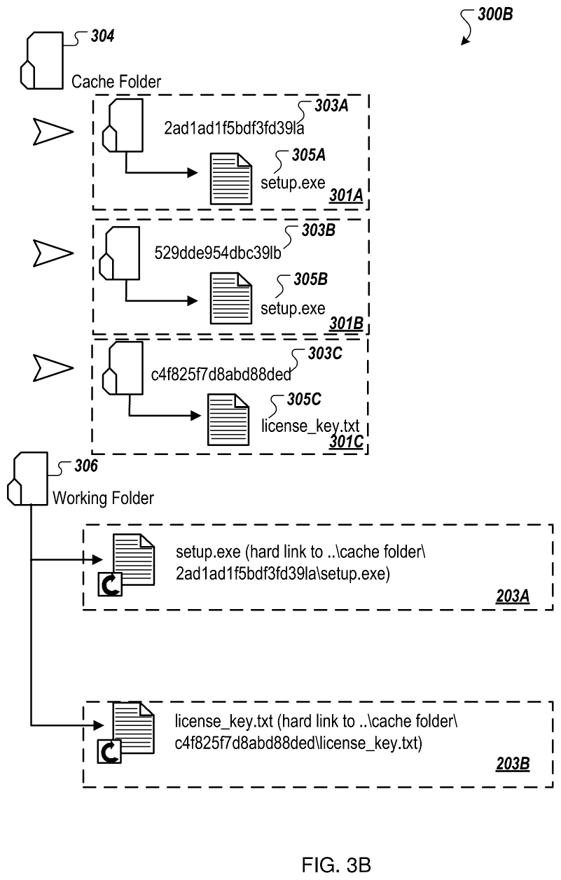

The folder module 212 may create the hard link 203 to the local executable 202C. For instance, after the subfolder is generated, the folder module 212 may create a hard link 203 to the local executable 202C and store the hard link 203 in the folders 117. In some embodiments, the hard link 203 may be stored in a cache folder or in a working folder that is included in the folders 117. Some example folder structures 300A and 300B that depict multiple subfolders and multiple hard links are described with reference to FIGS. 3A and 3B.

The hard link 203 enables the local executable 202C to be accessible by the local installation module 208. For instance, to execute the local executable 202C, the local installation module 208 may use the hard link 203 to access the local executable 202C and run it, which installs the software package 224 in the products 115. The hard link 203 may be preserved while the local executable 202C is run. The hard link 203 may be removed after the local executable 202C is complete.

In some embodiments, after the local executable 202C is stored in the folders 117, the second node 106B may receive the installation instruction 222 from the management device 102 to install the software package 224. The package distribution module 144 of the second node 106B may detect the designation parameter associated with the software package 224. The package distribution module 144 may generate the subfolder name based on the designation parameter and search the folders 117 of the second node 106B (e.g., a second cache folder) for the executable (e.g., 202A or 202B) based on the subfolder name. The package distribution module 144 of the second node 106B may search the folders 117 at the second node 106B and the first node 106A (and another peer node). Responsive to executable 202 being stored in the folders 117 of the second node 106B (e.g., executable 202A), the package distribution module 144 may access and execute the local executable 202A to install the software package 224.

Responsive to the executable 202 being unavailable at the folders 117 of the second node 106B, the package distribution module 144 may search for the executable 202 in the folders 117 of the first node 106A based on the subfolder name. Responsive to the executable 202 being available at the first node 106A (e.g., the local executable 202C), the package distribution module 144 of the second node 106B may access the local executable 202C in the folders 117 of the first node 106A. The package distribution module 144 of the second node 106B may copy and store the executable 202 in the folders 117 at the second node 106B. The package distribution module 144 of the second node 106B may create a hard link in the folders 117 and execute the executable 202A using the created hard link.

Response to the executable being unavailable at the second node 106B and the first node 106A, the package distribution module 144 may access the executable at the network address 151 of the third-party server 109. The package distribution module 144 may then create a subfolder and hard link, which are used to execute the executable 202 and install the software package 224 at the second node 106B.

Additionally, in some embodiments, the first node 106A may receive additional installation instructions 222 that relate to a second software package from the management device 102. Like the software package 224, an additional executable is configured to install the second software package and may be available at a second network address (e.g., 151) and have an additional URL that points to the second network address.

The folder module 212 may detect an additional designation parameter related to the second software package and generate an additional subfolder name based on the additional designation parameter. The search module 210 may search the folders 117 of the first and second nodes 106A and 106B for the additional executable.

If the additional executable is available at either of the first and second nodes 106A and 106B, the local installation module 208 may execute or access and execute the additional executable. For instance, in some embodiments, the local installation module 208 may copy the executable to the folders 117. The copied executable may be stored in a subfolder having the generated subfolder name. The local installation module 208 may then create a hard link 203 in the folders 117 (e.g., in a local cache folder or a working folder). The local installation module 208 may then execute the executable 202 using the hard link 203.

Responsive to the additional executable being unavailable at the folders 117 of the first and second nodes 106A and 106B, the package distribution module 144 may access the additional executable from a network address using the URL. The folder module 212 may generate an additional subfolder in the folders 117 and create a hard link to the additional executable. The additional subfolder is named according to the subfolder name, which is based on the designation parameter. The additional executable may be stored in the additional subfolder.

The subfolder and the additional subfolder are named using the subfolder names based on the designation parameter and the additional designation parameter, respectively. This naming convention enables storage of the additional executable and the executable to generate separate full paths despite their filenames. Accordingly, the executable and the additional executable may have the same name. In conventional storage structures, the same name may create processing inefficiencies. However, in the process 200 of FIG. 2, the executable and the additional executable are stored in separate subfolders, which may enable discovery and access to the executable and the additional executable via separate full paths.

Moreover, the naming convention and storage operations of the executable 202 and the additional executable generates independent full paths in the folders 117. Thus, the executable 202 and the additional executable may occur concurrently or at least partially concurrently. For instance, the installation instruction 222 and the additional installation instructions may be received at the first node 106A at approximately the same time. Additionally or alternatively, the additional installation instructions may be received while the software package 224 is being installed even when the executable 202 and the additional executable have the same name. The subfolders, by nature of the naming convention, establish separate full paths to discover the executable 202 and the additional executable.

FIGS. 3A and 3B depict example folder structures 300A and 300B that may be implemented in the process 200 of FIG. 2. The folder structures 300A and 300B represent structures of folders and subfolders that may be implemented in the folders 117 described in FIGS. 1 and 2. The folder structures 300A and 300B illustrate subfolders 301A-301C and hard links 203A-203C that may be generated during a software product distribution process such as the process 200 of FIG. 2. As described elsewhere in the present disclosure, a designation parameter may be detected. The designation parameter may be a characteristic of a software package and/or the executable that is detectable by the nodes 106 after an installation instruction (e.g., installation instruction 222 of FIG. 2) is received. The designation parameter may include the URL of an executable (e.g., 202 and 305A-305C of FIGS. 3A and 3B) that is executed to install the software package or may be an identifier assigned to the software package, for instance. A subfolder name (in FIGS. 3A and 3B, 303A-303C) may be generated based on the designation parameter. The folder structures 300A and 300B depict examples of the organizational structures for the executables, subfolders, and hard links (in FIGS. 3A and 3B, 203A-203C) generated during this process.

In FIGS. 3A and 3B, the folder structures 300A and 300B include a cache folder 304. The cache folder 304 may include a folder that exists on nodes such as the nodes 106 of FIGS. 1 and 2. The cache folder 304 may be configured to store temporary files such that the files are accessible to a processor. Additionally, the cache folder 304 of FIGS. 3A and 3B may be searched. For instance, the processor of a node may search the cache folder 304 when attempting to find a local executable and/or responsive to a request from a peer node in a managed network.

The folder structures 300A and 300B include three subfolders 301A-301C (generally, subfolder 301 or subfolders 301). The subfolders 301 are stored in the cache folder 304. Each of the subfolders 301 includes a subfolder name 303A-303C (generally, subfolder name 303 or subfolder names 303). For instance, a first subfolder 301A may have a first subfolder name 303A, a second subfolder 301B may have a second subfolder name 303B, and a third subfolder 301C may have a third subfolder name 303C.

The subfolder names 303 may be derived from a designation parameter. For instance, in FIGS. 3A, the subfolder names 303 include a first seven characters of a URL hash value. In particular, the first subfolder 301A is generated to store a first executable 305A called “setup.exe.” The first executable 305A may be located at a first URL “www.first.executable.networkaddress.com/setup.exe.” The first URL may be a first designation parameter. To generate the first subfolder name 303A, a hash value of the first URL may be calculated using a SHA-1 or another suitable hash function. The result of the application of the SHA-1 to the first URL may be a first URL hash value “2ad1ad1f5bdf3fd391a.” The first subfolder name 303A may accordingly equal “2ad1ad1.” The first executable 305A may be stored in the first subfolder 301A without changing the name of the first executable 305A. Similarly, the second subfolder 301B is generated to store a second executable 305B, which is also called “setup.exe.” The second executable 305B may be located at a second URL “www.second.executable.networkaddress.com/setup.exe.” The second URL may be a second designation parameter. To generate the second subfolder name 303B, a hash value of the second URL may be calculated using a SHA-1 or another suitable hash function. The result of the application of the SHA-1 to the second URL may be a second URL hash value “529dde954dbc391b.” The second subfolder name 303B may accordingly equal “529dde9.” The second executable 305B may be stored in the second subfolder 301B without changing the name of the second executable 305B.

In the embodiments of FIGS. 3A, the subfolder names 303 are the first seven characters of the URL hash value. In other embodiments, the subfolder names 303 may have a different length (e.g., five, six, seven, eight, etc.). For instance in FIG. 3B, the subfolder names 303 may include the entire URL hash value instead of the first seven characters of the URL hash values. For instance, the first subfolder name 303A in FIG. 3B is “2ad1ad1f5bdf3fd391a” and the second subfolder name 303B in FIG. 3B is 529dde954dbc391b. Additionally or alternatively, the subfolder names 303 may be derived from another portion of the URL hash values such as the final characters, a central portions, etc. Additionally still, in some embodiments the subfolder names 303 may be derived from an identifier associated with a software package or may be a portion thereof.

In FIGS. 3A and 3B, the first and the second executables 305A and 305B may have the same name. However, the first and the second executables 305A and 305B may have different full paths because the first and the second subfolders 301A and 301B have different names derived from the hash values of the URLs or other designation parameters in other embodiments.

The folder structures 300A and 300B also include hard links 203A and 203B (generally, hard link 203 or hard links 203) that correspond to a subset of the executables 305. For instance, a first hard link 203A corresponds to the first executable 305A and a second hard link 203B corresponds to the third executable 305C. The hard links 203 direct a processor to the executables 305 in the subfolders 301. For instance, the first hard link 203A points to the first executable 305A. Specifically, the first hard link 203A points to the first executable 305A in the first subfolder 301A.

In FIG. 3A, the hard links 203 are included in the cache folder 304. The first hard link 203A includes “.\2ad1ad1\setup.exe”, in which the first subfolder name 303A “2ad1ad1” is referenced and the name of the first executable 305A “setup.exe” is referenced. Similarly, the second hard link 203B includes a full path to the third executable 305C, which is directed to through the third subfolder 301C. As shown in FIG. 3A, the second hard link 203B includes “.\c4f825\license_key.txt” , in which the third subfolder name 303C “c4f825f” is referenced and the name of the third executable 305C “license_key.txt” is referenced.

In the embodiment of FIG. 3B, the hard links 203 are stored in a working folder 306. The working folder 306 may be separate from the cache folder 304 and may be a sibling folder to the cache folder 304. The working folder 306 may be used to avoid accidental deletion of the executables 305 and to provide a known or clean workspace for installation operations. The hard links 203 of the embodiment of FIG. 3B are different from those in the embodiment of FIG. 3A. The hard links 203 include a full path back to the cache folder 304 and the longer subfolder name 303. For instance, the first hard link 203A includes “ . . . \cache folder\2ad1ad1f5bdf3fd391a\setup.exe”, in which the cache folder is referenced, the first subfolder name 303A “2ad1ad1f5bdf3fd391a” is referenced, and the name of the first executable 305A “setup.exe” is referenced. Similarly, the second hard link 203B includes a full path to the third executable 305C, which is directed to through the cache folder 304 and the third subfolder 301C. As shown in FIG. 3B, the second hard link 203B includes “ . . . \cache folder\c4f825f7d8abd88ded\license_key.txt”, in which the cache folder 304 is referenced, the third subfolder name 303C “c4f825f7d8abd88ded” is referenced, and the name of the third executable 305C “license_key.txt” is referenced.

As discussed elsewhere in the present disclosure, the hard links 203 may be used during an installation operation. For instance, in some embodiments, the subfolders 301 may be generated and the executables 305 may be stored therein. In addition, the hard links 203 may be generated to direct a processor to the executable 305 in one of the generated subfolders 301. The hard links 203 may be preserved during an installation operation and removed after the installation operation is complete.

There is not a hard link 203 to the second executable 305B in FIGS. 3A and 3B. In the depicted embodiment, two hard links 203 having the same name (e.g., “setup.exe”) may not exist in the same folder (e.g., the cache folder 304 or the working folder 306). Accordingly, the hard links 203 may be removed after the corresponding software package is installed.

FIG. 4 illustrates an example computing system 400 configured for software package distribution according to at least one embodiment of the present disclosure. The computing system 400 may be implemented in the operating environment 100 of FIG. 1 or another suitable operating environment. Examples of the computing system 400 may include the node 106, the management device 102, the third-party server 109, or some combination thereof. The computing system 400 may include one or more processors 410, a memory 412, a communication unit 414, a user interface device 416, and a data storage 404 that includes the package distribution module 144 and the distribution management module 148 (collectively, modules 144/148).

The processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 4, the processor 410 may more generally include any number of processors configured to perform individually or collectively any number of operations described in the present disclosure. Additionally, one or more of the processors 410 may be present on one or more different electronic devices or computing systems. In some embodiments, the processor 410 may interpret and/or execute program instructions and/or process data stored in the memory 412, the data storage 404, or the memory 412 and the data storage 404. In some embodiments, the processor 410 may fetch program instructions from the data storage 404 and load the program instructions in the memory 412. After the program instructions are loaded into the memory 412, the processor 410 may execute the program instructions.

The memory 412 and the data storage 404 may include computer-readable storage media for carrying or having computer-executable instructions or data structures stored thereon. Such computer-readable storage media may include any available media that may be accessed by a general-purpose or special-purpose computer, such as the processor 410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

The communication unit 414 may include one or more pieces of hardware configured to receive and send communications. In some embodiments, the communication unit 414 may include one or more of an antenna, a wired port, and modulation/demodulation hardware, among other communication hardware devices. In particular, the communication unit 414 may be configured to receive a communication from outside the computing system 400 and to present the communication to the processor 410 or to send a communication from the processor 410 to another device or network (e.g., the network 120 of FIG. 1).

The user interface device 416 may include one or more pieces of hardware configured to receive input from and/or provide output to a user. In some embodiments, the user interface device 416 may include one or more of a speaker, a microphone, a display, a keyboard, a touch screen, or a holographic projection, among other hardware devices.

The modules 144/148 may include program instructions stored in the data storage 404. The processor 410 may be configured to load the modules 144/148 into the memory 412 and execute the modules 144/148. Alternatively, the processor 410 may execute the modules 144/148 line-by-line from the data storage 404 without loading them into the memory 412. When executing the modules 144/148, the processor 410 may be configured to perform one or more processes or operations described elsewhere in this disclosure.

Modifications, additions, or omissions may be made to the computing system 400 without departing from the scope of the present disclosure. For example, in some embodiments, the computing system 400 may not include the user interface device 416. In some embodiments, the different components of the computing system 400 may be physically separate and may be communicatively coupled via any suitable mechanism. For example, the data storage 404 may be part of a storage device that is separate from a device, which includes the processor 410, the memory 412, and the communication unit 414, that is communicatively coupled to the storage device. The embodiments described herein may include the use of a special-purpose or general-purpose computer including various computer hardware or software modules, as discussed in greater detail below.

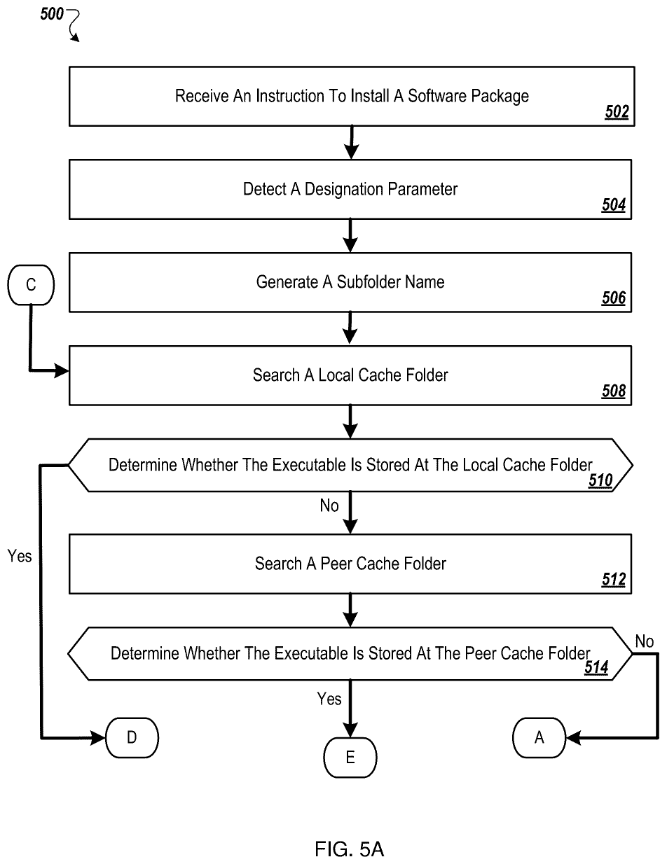

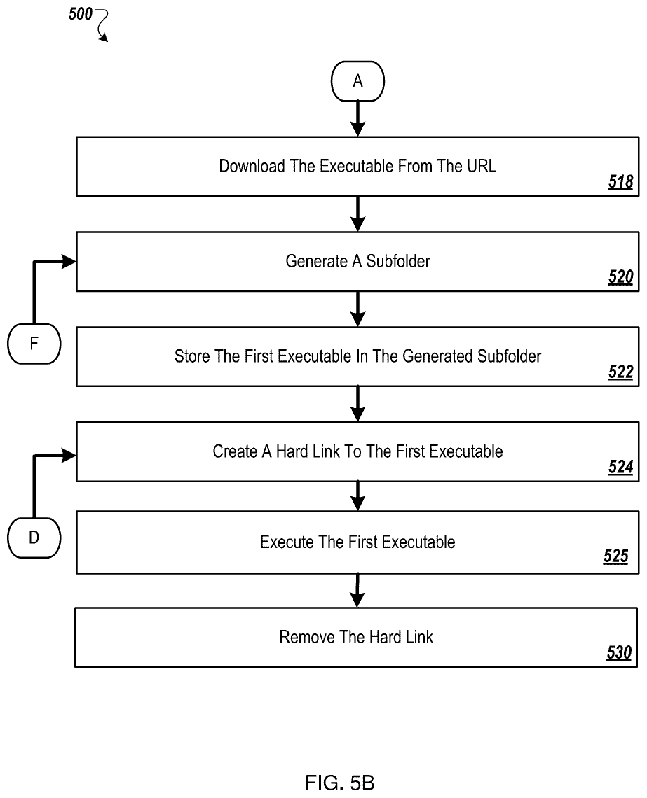

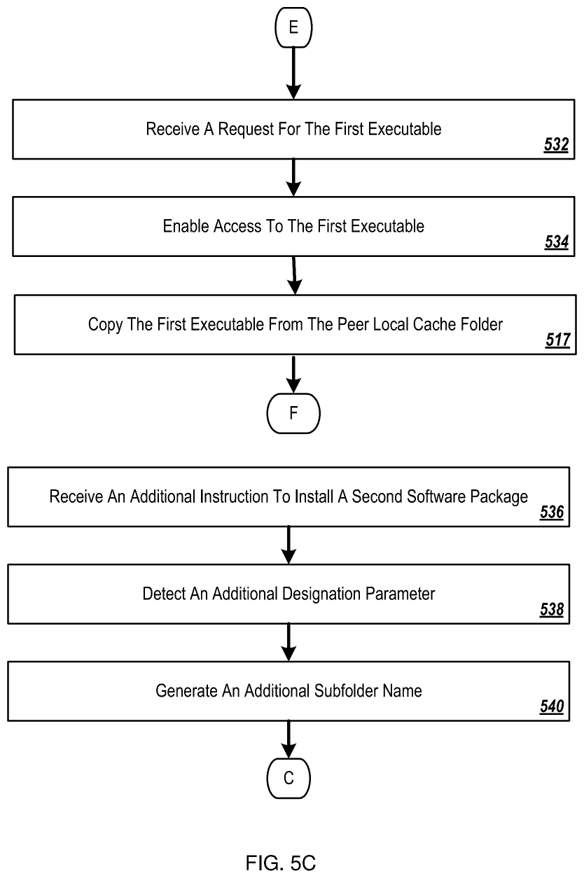

FIGS. 5A-5C are a flow chart of an example method 500 of executable storage in a peer-to-peer based software package distribution system, according to at least one embodiment of the present disclosure.

Referring to FIG. 5A, the method 500 may begin at block 502, in which an instruction to install a software package may be received. The instruction may be received at a first node of a managed network. The first software package may include an update to an application, a new application, etc. In some embodiments, a first executable may be configured to execute installation of the first software package. The executable may be available at a network location that corresponds to a first URL. At block 504, a designation parameter may be detected. The designation parameter may be detected responsive to the instruction. The designation parameter may be detected from a characteristic of the first executable and/or the first URL. For instance, the characteristic may include the first URL, which may be distinctive or unique and identifiable. Additionally or alternatively, the characteristic may include an identifier (e.g., a UNID) assigned to a package including the software package. The characteristic is not limited to the URL hash value or the UNID. For instance, the characteristic may include any unique or substantially unique value that is associated with the software package, the executable, etc. that is detectable by a node of a managed network.

At block 506, a subfolder name may be generated. The subfolder name may be generated based on the designation parameter. In some embodiments, generation of the subfolder name may include performing an operation on the designation parameter. For instance, in embodiments in which the characteristic is the first URL, the operation may include performance of a hash operation (e.g., secured hash algorithm 1 (SHA-1)) to generate a first URL hash value. The subfolder name may include at least a portion of the first URL hash value such as a first six, seven, eight, or another suitable number of characters of the first URL hash value. In some embodiments in which the characteristic includes the UNID of the package, the subfolder name may include a least a portion or a derivative of the UNID.

At block 508, a local cache folder may be searched. The local cache folder may be searched for the first executable based on the subfolder name. For instance, the method 500 results in the executable being stored in a subfolder having the subfolder name based on the designation parameter. The search of the local cache folder includes reviewing the local cache folder for the subfolder having the subfolder name. At block 510, it may be determined whether the executable is stored at the local cache folder. For instance, the search may determine whether the subfolder having the subfolder name exists in the local cache folder. Responsive to the first executable being unavailable at the local cache folder (“No” at block 510), the method 500 may proceed to block 512. Responsive to the first executable being available at the local cache folder (“Yes” at block 510), the method 500 may proceed to block 524 of FIG. 5B.

At block 512, a peer cache folder may be searched. The peer cache folder may exist at a peer node of the managed network. As described above, the method 500 may result in the executable being stored in a subfolder having the subfolder name. Accordingly, the search of the peer cache folder may include a search for the subfolder. The first node, which receives the instruction to install the software package, may independently derive the subfolder name. The subfolder name may also be derived by any peer node that receives the instruction to install the software package.

At block 514, it may be determined whether the executable is stored at the peer cache folder. Responsive to the first executable being unavailable at the peer cache folder (“No” at block 514), the method may proceed to block 518 of FIG. 5B. Responsive to the first executable being available at the peer cache folder (“Yes” at block 514), the method may proceed to block 532 of FIG. 5C.

Referring to FIG. 5B, at block 518 the first executable may be downloaded from the first URL. For instance, in some embodiments, a node that receives the instruction to install the software package may search the local cache folder. If the executable is unavailable at the local cache folder, then the node may search one or more peer cache folders. If the executable is unavailable at the one or more peer cache folders, then the node may download the executable from a network address (e.g., at a third-party server 109) that corresponds to the first URL. The executable may be executed to install the software package.

At block 520, a subfolder may be generated. The subfolder may be generated for the first executable in the local cache folder. The subfolder may have the subfolder name generated from the designation parameter such as the first seven characters of a hash of the first URL. At block 522, the executable may be stored in the generated subfolder. At block 524, a hard link may be created to the executable stored in the subfolder. In some embodiments, the hard link may be stored in the local cache folder. In some embodiments, the hard link may be stored in a working folder. The hard link may be used by the node to access the executable and install the software package. At block 525, the first executable may be executed. For instance, the first executable may be executed by triggering the hard link created at block 524. The hard link may be preserved while the executable is run or executed. At block 530, the hard link may be removed. For instance, the hard link may be removed after the executable is complete and/or the software package is installed.

Referring to FIG. 5C, at block 532 a request may be received for the first executable. For instance, the peer node may receive the request for the first executable. The request may be based on the subfolder name. As discussed above, the first node may be requesting the first executable in response to an instruction to install the software package and the executable being unavailable at the local cache folder. At block 534, access to the executable may be enabled. For instance, access may be enabled to the executable stored in a generated subfolder responsive to the request. The access may be enabled by the peer node.

At block 517 the first executable may be copied. For example, in response the first node may locate the first executable at the peer node in a subfolder having the generated subfolder name. The first node may then copy the first executable. From block 517, the method 500 may proceed to block 520 of FIG. 5B. The method 500 may proceed through blocks 520, 522, 524, 525, 530, or some combination thereof to install the software package.

Block 536, 538, and 540 may be optional operations related to a second or subsequent software package. At block 536, an additional instruction may be received. The additional instruction may be received to install a second software package. A second executable that is configured to execute installation of the second software package may be available at an additional network location that corresponds to a second URL. The second executable may have the same name as the executable for the first software package or any other earlier-installed software package. At block 538, an additional designation parameter may be detected. The additional designation parameter may be specific or unique to the second software package, the second executable, the second URL, etc.

At block 540, an additional subfolder name may be generated. The additional subfolder name may be generated based on the additional designation parameter. The additional subfolder name may be generated in a similar way to the operations described with reference to block 506. From block 540, the method 500 may proceed to block 508. From block 508, the method 500 may proceed through block 510, 512, 514, 516, 518, 520, 522, 524, 528, 530, or some combinations thereof. For instance, the method 500 may proceed to blocks 510, 512, 514, and 516. In this circumstance, the local cache folder may be searched for the second executable based on the additional subfolder name. Responsive to the second executable being unavailable at the local cache folder, the peer cache folder may be searched for the second executable in the peer node(s) based on the additional subfolder name. Responsive to the second executable being available at the peer cache folder (“YES” at block 514), the second executable may be accessed from the peer cache folder and the second executable may be executed to install the second software package (e.g., block 516).

Additionally, the method 500 may proceed through blocks 508, 510, 512, 514, 518, 520, and 522. For example, the local cache folder may be searched for the second executable based on the additional subfolder name. Responsive to the second executable being unavailable at the local cache folder, the peer cache folder may be searched for the second executable in the peer node(s) based on the additional subfolder name. Responsive to the second executable being unavailable at the peer cache folder (“NO” at block 514), an additional subfolder may be generated for the second executable in the local cache folder. The additional subfolder may have the additional subfolder name. The second executable may be stored in the additional subfolder such that the first executable and the second executable include unique full paths via which the first executable and the second executable are accessible despite having the same name. In some embodiments, the method 500 or portions thereof may be executed concurrently or at least partially concurrently. For instance, execution of the first executable and execution of the second executable may occur concurrently or at least partially concurrently.

Although illustrated as discrete blocks, one or more blocks in FIGS. 5A-5C may be divided into additional blocks, combined into fewer blocks, or eliminated, depending on the desired implementation. One or more of the methods described in the present disclosure may be performed in a suitable operating environment such as the operating environment 100. The method 500 may be performed by the nodes 106, the package distribution module 144, or some combination thereof. In some embodiments, the node 106 or another computing system may include or may be communicatively coupled to a non-transitory computer-readable medium (e.g., the memory 412 of FIG. 4) having stored thereon programming code or instructions that are executable by one or more processors (such as the processor 410 of FIG. 4) to cause a computing system or the node 106 to perform or control performance of the methods. Additionally or alternatively, the node 106 may include the processor 410 described elsewhere in this disclosure that is configured to execute computer instructions to cause the node 106 or another computing systems to perform or control performance of the methods.

Further, modifications, additions, or omissions may be made to the methods without departing from the scope of the present disclosure. For example, the operations of methods may be implemented in differing orders. Furthermore, the outlined operations and actions are only provided as examples, and some of the operations and actions may be optional, combined into fewer operations and actions, or expanded into additional operations and actions without detracting from the disclosed embodiments.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of executable storage in a peer-to-peer based software package distribution system, the method comprising:
receiving, at a first node of a managed network, an instruction to install a first software package, wherein a first executable configured to execute installation of the first software package is available at a network location that corresponds to a first uniform resource location (URL);
responsive to the instruction, detecting a designation parameter from a characteristic of the first executable or the first URL;
generating a subfolder name based on the designation parameter;
searching a local cache folder for the first executable based on the subfolder name;
responsive to the first executable being unavailable at the local cache folder, searching for the first executable in a peer cache folder of a peer node based on the subfolder name;
responsive to the first executable being unavailable at the peer cache folder, downloading the first executable from the first URL;
generating a subfolder for the first executable in the local cache folder, the subfolder having the generated subfolder name; and
storing the first executable in the generated subfolder.

2. The method of claim 1, wherein the generating the subfolder name includes performing an operation on the designation parameter.

3. The method of claim 2, wherein:
the characteristic is the first URL;
the operation includes a hash operation to generate a first URL hash value; and
the subfolder name includes at least a portion of the first URL hash value.

4. The method of claim 3, wherein:
the hash operation is performed using secured hash algorithm 1 (SHA-1); and
the subfolder name includes a first seven characters of the first URL hash value.

5. The method of claim 1, wherein the characteristic includes an identifier assigned to a package including the first software package; and the subfolder name includes at least a portion of the identifier.

6. The method of claim 1, further comprising after the subfolder is generated, creating a hard link to the first executable in the local cache folder or in a working folder.

7. The method of claim 6, further comprising:
preserving the hard link while the first executable is run; and
removing the hard link after the first executable is complete.

8. The method of claim 1, further comprising:
receiving a request from the peer node for the first executable, the request being based on the subfolder name; and
responsive to the request, enabling access to the first executable stored in the generated subfolder.

9. The method of claim 1, further comprising:
receiving an additional instruction to install a second software package, wherein a second executable configured to execute installation of the second software package is available at an additional network location that corresponds to a second executable uniform resource location (URL);
responsive to the additional instruction, detecting an additional designation parameter from a characteristic of the second executable or the second URL;
generating an additional subfolder name based on the designation parameter;
searching the local cache folder for the second executable based on the subfolder name;
responsive to the second executable being unavailable at the local cache folder, searching for the second executable in the peer cache folder of the peer nodes based on the additional subfolder name;
responsive to the second executable being available at the peer cache folder, accessing the second executable from the peer cache folder; and
executing the second executable to install the second software package.

10. The method of claim 1, further comprising:
receiving an additional instruction to install a second software package, wherein a second executable configured to execute installation of the second software package is available at an additional network location that corresponds to a second executable uniform resource location (URL) and the second executable having a same name as the first executable;
responsive to the instruction, detecting an additional designation parameter from a characteristic of the second executable or the second URL;
generating an additional subfolder name based on the designation parameter;
responsive to the second executable being unavailable at the local cache folder and the second executable being unavailable at the peer cache folder:
generating an additional subfolder for the second executable in the local cache folder, the additional subfolder having the additional subfolder name; and
storing the second executable in the additional subfolder such that the first executable and the second executable include unique full paths via which the first executable and the second executable are accessible despite having the same name.

11. The method of claim 10, wherein execution of the first executable and execution of the second executable occur concurrently or at least partially concurrently.

12. A managed network configured for peer-to-peer based software package distribution, the managed network comprising:
a plurality of nodes including a first node and a second node, wherein the first node includes a first cache folder and the second node include a second cache folder;
a management device configured to communicate instructions to the plurality of nodes to install software packages,
wherein the first node is configured to:
receive a first instruction from the management device to install a first software package, the first software package is installed via execution of a first executable available at a first network location that corresponds to a first uniform resource location (URL);
detect a first designation parameter from a characteristic of the first executable or the first URL responsive to the first instruction;
generate a first subfolder name based on the first designation parameter;
search the first cache folder of the first node for the first executable based on the first subfolder name;
search for the first executable in the second cache folder of the second node based on the first subfolder name responsive to the first executable being unavailable at the first cache folder;
download the first executable from the first URL responsive to the first executable being unavailable at the second cache folder;
generate a first subfolder for the first executable in the first cache folder, the first subfolder having the first subfolder name; and
store the first executable in the first subfolder; and
the second node is configured to:
receive a second instruction from the management device to install the first software package;
detect the first designation parameter;
generate the first subfolder name based on the first designation parameter;
search the second cache folder of the second node for the first executable based on the first subfolder name;
search for the first executable in the first cache folder of the first node based on the first subfolder name responsive to the first executable being unavailable at the second cache folder;
access the first executable in the first cache folder of the first node; and
execute the first executable to install the first software package.

13. The managed network of claim 12, wherein the first node is further configured to:
receive an additional instruction to install a second software package from the management device, wherein a second executable is configured to install the second software package and is available at an additional network location that corresponds to a second uniform resource location (URL);
responsive to the additional instruction, detect an additional designation parameter from a characteristic of the second executable or the second URL;
generate an additional subfolder name based on the additional designation parameter;
search the first cache folder of the first node for the second executable based on the first subfolder name;
responsive to the second executable being unavailable at the first cache folder of the first node, search for the second executable in the second cache folder of the second node based on the additional subfolder name;
responsive to the second executable being available at the second cache folder of the second node, access the second executable from the second cache folder of the second node; and
execute the second executable to install the second software package.

14. The managed network of claim 12, wherein the first node is further configured to:
receive an additional instruction to install a second software package from the management device, wherein a second executable is configured to install the second software package, the second executable is available at an additional network location that corresponds to a second uniform resource location (URL), and the second executable has a same name as the first executable;
responsive to the additional instruction, detect an additional designation parameter from a characteristic of the second executable or the second URL;
generate an additional subfolder name based on the additional designation parameter;
responsive to the second executable being unavailable at the first cache folder at the first node and the second executable being unavailable at the second cache folder of the second node:
generate an additional subfolder for the second executable in the first cache folder of the first node, the additional subfolder having the additional subfolder name; and
store the second executable in the additional subfolder such that the first executable and the second executable include unique full paths via which the first executable and the second executable are accessible despite having the same name.

15. The managed network of claim 14, wherein execution of the first executable and execution of the second executable occur concurrently or at least partially concurrently.

16. The managed network of claim 12, wherein:
the first node generates the first subfolder name based on performance of an operation on the first designation parameter;
the characteristic is the first URL;
the operation includes a hash operation to generate a first URL hash value; and
the first subfolder name includes at least a portion of the first URL hash value.

17. The managed network of claim 16, wherein:
the hash operation is performed using secured hash algorithm 1 (SHA-1); and
the first subfolder include a first seven characters of the first URL hash value.

18. The managed network of claim 12, wherein:
the characteristic includes an identifier assigned to a package including the first software package; and
the first subfolder name includes at least a portion of the identifier.

19. The managed network of claim 12, wherein the first node is further configured to:
create a hard link to the first executable, the hard link being created after the first subfolder is generated in the first cache folder of the first node;
preserve the hard link while the first executable is run; and
remove the hard link after the first executable is complete.

20. The managed network of claim 12, wherein the first node is further configured to:
create a hard link to the first executable, the hard link being created after the first subfolder is generated in a working folder of the first node;
preserve the hard link while the first executable is run; and
remove the hard link after the first executable is complete.
